(19) United States
(12) Patent Application Publication
(10) Pub. No.: US 2002/0144037 A1
(43) Pub. Date: Oct. 3, 2002

(54) Data fetching mechanism and method for fetching data

(76) Inventors: Joseph A. Bennett, Roseville, CA (US); Adit D. Tarmaster, Citrus Heights, CA (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/819,996

(22) Filed: Mar. 29, 2001

(51) Int. Cl. G06F 13/42

(52) U.S. Cl. 710/105

(57) ABSTRACT

A method and apparatus are provided for fetching data from a memory component. Parameters relating to data fetching may be obtained based on an operating frequency of a bus. These parameters may be stored in registers and include an initial request length, an initial threshold length, a subsequent request length, and a subsequent threshold length. Data may be fetched from the memory component based on the obtained parameters.

### FIELD

The present invention relates to data fetching. More particularly, the present invention relates to a data fetching mechanism and method of fetching data for bus devices.

### BACKGROUND

Computer systems may utilize one or more buses as an interconnect transportation mechanism to transfer data between different internal components, such as one or more processors, memory subsystems and input/output (I/O) devices including, for example, keyboards, input mouses, disk controllers, serial and parallel ports to printers, scanners, and display devices. For computer systems using processors such as the 8088, 8086, 80186, i386™ and i486™ microprocessors designed and manufactured by Intel Corporation, such buses have typically been designed as either an Industry Standard Architecture (ISA) bus or an Expanded Industry Standard Architecture (EISA) bus. The ISA bus is a sixteen (16) bit data bus while the EISA bus is thirty-two (32) bits wide. Each of these buses may function at a frequency of eight (8) megahertz. However, the data transfer rates provided by these bus widths and operational frequencies may be limited.

For recent computer systems, such as servers, workstations or personal computers (PCs) using a “Pentium®” family of microprocessors (manufactured by Intel Corporation), for example, such buses may be Peripheral Components Interconnect (PCI) buses. The PCI buses are high performance 32 or 64 bit synchronous buses with automatic configurability and multiplexed address, control and data lines as described in the version of “PCI Local Bus Specification, Revision 2.2” set forth by the PCI Special Interest Group (SIG) on Dec. 18, 1998. The PCI architecture may provide the most common method used to extend computer systems for add-on arrangements (e.g., expansion cards) with new video, networking, or disk memory storage capabilities.

When PCI buses are used as an interconnect transportation mechanism in a host system (e.g., server, workstation or PC), data transfer between a processor, a memory subsystem and I/O devices may be executed at high speed. Bridges may be provided to interface and buffer transfers of data between the processor, the memory subsystem, the I/O devices and the PCI buses. Examples of such bridges may include PCI-PCI bridges as described in detail in the “PCI-PCI Bridge Architecture Specification, revision 1.1” set forth by the PCI Special Interest Group (SIG) on Apr. 5, 1995. However, the performance of such a host system may be burdened by a significant amount of time required to process read requests from PCI devices (e.g., I/O devices that conform to the PCI Local Bus Specification for operation) to access memory locations of the memory subsystems, via the PCI buses, during data memory read operations. Existing data fetching schemes for PCI devices, however, fail to optimize the PCI bus operation. Typically, data fetched from the memory subsystem are at a standard size, and may not be optimized at various fetch sizes for PCI devices behind or on one side of a host bridge such as a PCI-PCI bridge based upon a particular request. As a result, the memory read operations may not be maximized, and the wait time between memory read operations may be unnecessarily lengthened.

Accordingly, there is a need for an efficient data fetching control mechanism that fetches data from a memory subsystem on one side of a host bridge such as a PCI-PCI bridge for PCI devices on the other side of the host bridge.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto.

The following represents brief descriptions of the drawings wherein like reference numerals represent like elements and wherein:

FIG. 1 illustrates one embodiment of a computer system platform having a data fetching mechanism according to an example embodiment of the present invention;

FIG. 2 is a flowchart showing an example embodiment of the present invention; and

FIG. 3 illustrates a register provided within a bridge according to an example embodiment of the present invention.

### DETAILED DESCRIPTION

In the following detailed description, like reference numerals and characters may be used to designate identical, corresponding or similar components in differing figure drawings. Further, in the detailed description to follow, example sizes/models/values/ranges may be given, although the present invention is not limited to the same. Further, arrangements may be shown in block diagram form in order to avoid obscuring the invention, and also in view of the fact that specifics with respect to implementation of such block diagram arrangements may be highly dependent upon the platform within which the present invention is to be implemented. That is, such specifics should be well within the purview of one skilled in the art. Where specific details (e.g., circuits, flowcharts) are set forth in order to describe example embodiments of the invention, it should be apparent to one skilled in the art that the invention can be practiced without, or with variation of, these specific details. Finally, it should be apparent that differing combinations of hard-wired circuitry and software instructions can be used to implement embodiments of the present invention. That is, the present invention is not limited to any specific combination of hardware and software.

Further, any reference in the specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

The present invention may be applicable for use with all types of system and peripheral buses, bridges and chipsets, including chipsets with PCI 64-bit hubs (P64H or P64H2) and P64H follow-on products, and new chipsets having internal buffers and data fetching control logics incorporated therein and new computer platforms that may become available as computer technology develops in the future. However, for the sake of simplicity, discussions will concentrate mainly on exemplary use of a PCI/PCI-X bus and a PCI/PCI-X bridge, although the scope of the present invention is not limited thereto. Further, the following discussion refers to PCI which is intended to correspond to PCI/PCI-X.

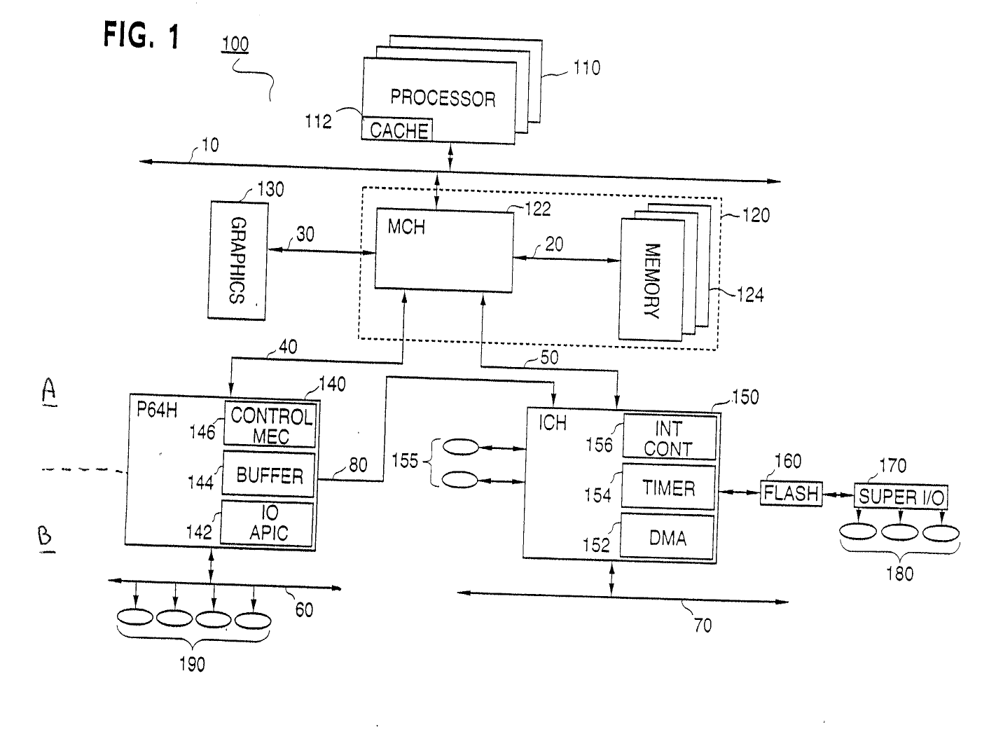

FIG. 1 illustrates an computer system platform having an example data fetching mechanism according to an example embodiment of the present invention. Other embodiments, mechanisms and platforms are also within the scope of the present invention. As shown in FIG. 1, the computer system 100 may include a processor subsystem 110, a memory subsystem 120 coupled to the processor subsystem 110 by a front side bus 10, graphics 130 coupled to the memory subsystem 120 by a graphics bus 30, one or more host chipsets (labeled 140-150) coupled to the memory subsystem 120 by hub links 40 and 50 for providing an interface with peripheral buses such as Peripheral Component Interconnect (PCI) buses 60 and 70 of different bandwidth and operating speeds, a flash memory 160, and a super I/O 170 coupled to the chipset 150 by a low pin count (LPC) bus for providing an interface with a plurality of I/O devices 180, including, for example, a keyboard controller for controlling operations of an alphanumeric keyboard, a cursor control device such as a mouse, track ball, touch pad, joystick, etc., a mass storage device such as magnetic tapes, hard disk drives (HDD), and floppy disk drives (FDD), and serial and parallel ports to printers, scanners, and display devices. A plurality of I/O devices 190 may be provided by the non-legacy PCI bus 60. The computer system 100 may be configured differently or employ some or different components than those shown in FIG. 1.

The processor subsystem 110 may include a plurality of host processors and a cache subsystem 112. The memory subsystem 120 may include a memory controller hub (MCH) 122 coupled to the host processors by a front side bus 10 (i.e., host or processor bus) and at least one memory element 124 coupled to the MCH 122 by a memory bus 20. The memory element 124 may be a dynamic random-access-memory (DRAM), or may be a read-only-memory (ROM), a video random-access-memory (VRAM) and the like. The memory element 124 stores information and instructions for use by the host processors. The graphics 130 may be coupled to the main controller hub 122 of the memory subsystem 120 by a graphics bus 30, and may include, for example, a graphics controller, a local memory and a display device (e.g., cathode ray tube, liquid crystal display, flat panel display, etc.).

The host chipsets (140 and 150) may be Peripheral Component Interconnect (PCI) bridges (e.g., host, PCI-PCI, or standard expansion bridges) in the form of PCI chips such as, for example, the PIIX4® chip and PIIX6® chip manufactured by Intel Corporation. In particular, the chipsets (140 and 150) may correspond to a Peripheral Component Interconnect (PCI) 64-bit hub (P64H bridge 140) and an input/output controller hub (ICH) 150. Embodiments of the present application are also applicable to a P64H2 hub although the following embodiments will be described with respect to the P64H hub. Further, although not shown, the bridge 140 may be coupled to more than one bus 60.

The P64H bridge 140 and the ICH 150 may be coupled to the MCH 122 of the memory subsystem 120 respectively by 16 bits and 8 bits hub links 40 and 50, for example, and may operate as an interface between the front side bus 10 and the peripheral buses 60 and 70 such as PCI buses of different bandwidths and operating speeds. The PCI buses may be high performance 32 or 64 bit synchronous buses with automatic configurability and multiplexed address, control and data lines as described in the latest version of “PCI Local Bus Specification, Revision 2.2” set forth by the PCI Special Interest Group (SIG) on Dec. 18, 1998 for add-on arrangements (e.g., expansion cards) with new video, networking, or disk capabilities. For example, the PCI bus 60 of 64-bits and 66 MHz may connect to the P64H bridge 140. Similarly, the PCI bus 70 of 32-bit and 33 MHz may connect to the ICH 150. Other types of bus architecture such as Industry Standard Architecture (ISA), Expanded Industry Standard Architecture (EISA) and PCI-X buses may also be utilized. These buses may operate at different frequencies such as 33 MHz, 66 MHz, 100 MHz and 133 MHz, for example. Other frequencies are also within the scope of the present invention.

In a preferred embodiment of the present invention, the hub links 40 and 50 that couple the P64H bridge 140 and the ICH 150 to the MCH 122 of the memory subsystem 120 may be primary PCI buses of different bandwidths and operating speeds. The peripheral buses 60 and 70 that couple the P64H bridge 140 and the ICH 150 to 1/0 devices may be secondary PCI buses having different bandwidths and operating speeds. The P64H bridge 140 and the ICH 150 may correspond to PCI-PCI bridges designed for compliance with the “PCI Local Bus Specification, Revision 2.2” set forth by the PCI Special Interest Group (SIG) on Dec. 18, 1998, and the “PCI Bus Power Interface (ACPI) and Power Management Interface Specification, Revision 1.1” set forth by the PCI Special Interest Group (SIG) on Jun. 30, 1997. Other hubs and bridges are also within the scope of the present invention.

The P64H bridge 140 may include an 10 Advanced Peripheral Interrupt Controller (APIC) 142 of an APIC system such as an Intel 82489DX APIC described in the “MultiProcessor Specification (MPS)” Version 1.1, September 1994, Intel Corp., internal buffers 144 and a data fetching control mechanism 146 constructed according to the principles of the present invention for controlling data transfers among the processors, the main memory 124 of the memory subsystem 120 and the PCI bus 60, including fetching data from the main memory 124 of the memory subsystem 120 in response to requests from PCI devices 190 (i.e., I/O devices connected to the PCI bus) via the PCI bus 60. The P64H bridge 140 may also include circuitry for interfacing the processor 110 and the main memory 124, and circuitry for interfacing to the PCI bus 60.

The internal buffers 144 may be provided to store data transfers among the processors, the main memory 124 of the memory subsystem 120 and the PCI bus 60 so that the transfers of data in either direction may be accelerated to enhance the speed of data transfer in the computer system. In particular, the internal buffers 144 may include a memory buffer (not shown) for holding data from a memory subsystem 120 on one side (side A) of the P64H bridge 140 for a particular PCI device 190 on the other side (side B) of the P64H bridge 140, and a command buffer (not shown) for holding commands from PCI devices 190 on side B of the P64H bridge 140 destined for a memory subsystem 120 on side A of the P64H bridge 140.

The data fetching control mechanism 146 may be integrated within the P64H bridge 140 rather than provided as a separate chip within a host chipset for simplicity. A group of PCI devices (I/O devices) 190 including, for example, multiple high performance peripherals in addition to graphics (motion video, LAN, SCSI, FDDI, hard disk drives, etc.) may be coupled to the PCI bus 60. Additional secondary bridges may also be coupled to the PCI bus 60 for providing data transfers between the PCI bus 60 and a secondary bus so that the data may be used by various component circuits joined to the secondary bus. The secondary bus may be an ISA bus, an EISA bus, or a similar bus, any of which typically transfers data at a rate slower than the PCI bus 60. Examples of secondary bridges may include those described in detail in a publication entitled “82420/82430 PCIset, ISA and EISA Bridges,” in 1993, Intel Corporation.

The ICH 150 may include a direct memory access (DMA) controller 152, a timer 154, an interrupt controller 156 such as an Intel 8259 PIC, universal serial bus (USB) ports and IDE ports for providing an interface to a hard disk drive (HDD) and a computer disk read-only-memory (CD-ROM). In addition, the P64H bridge 140 may optionally include an IO APIC of an APIC system for handling additional interrupts from the PCI bus 70 if additional interrupts are required.

The flash memory (e.g., EPROM) 160 and the super I/O 170 may be coupled to the ICH 150 via a low pin count bus. The flash memory 160 may store a set of system basic input/output start up (BIOS) routines at startup of the computer system 100. The super I/O 170 may provide an interface with a group of I/O devices 180 including, for example, a keyboard controller for controlling operations of an alphanumeric keyboard, a cursor control device such as a mouse, track ball, touch pad, joystick, etc., a mass storage device such as magnetic tapes, hard disk drives (HDD), floppy disk drives (FDD), and serial and parallel ports to printers, scanners, and display devices.

Data fetching schemes may fetch data from the main memory 120 of the memory subsystem 120 on one side (side A) of the P64H bridge 140 in response to requests from the PCI devices 190 via the PCI bus 60 on the other side (side B) of the P64H bridge 140. In disadvantageous embodiments, such data fetched from the memory subsystem 120 may be a standard fetch size and may not be optimized for the PCI devices 190 on the other side of the P64H bridge 140 in accordance with different fetch sizes requested. As a result, the memory read operations may not be maximized, and the wait time between memory read operations may not be minimized. A simple fetch algorithm may be utilized in advanced chipsets such as, for example, 440BX host bridge chipsets manufactured by Intel Corporation to enhance the memory efficiency. For instance, when a command is a PCI “memory read” command or “memory read line” command, a line of data may be fetched. When a command is a PCI “memory read multiple”, multiple lines of data may be fetched. However, the amount of data transfers between the PCI devices 190 on one side of the P64H bridge 140 and the main memory 124 of the memory subsystem 120 as shown in FIG. 1 may still require optimization.

The data fetching control mechanism 146 may be implemented to fetch data from the main memory 124 of the memory subsystem 120 on one side (side A) of a host bridge such as the P64H bridge 140 for the PCI devices 190 on the other side of the P64H bridge 140 in accordance with a particular request. The PCI bus command type may be a 4-bit command (such as, for example: “0110”, “1110” and “1100”) that indicates either a “memory read” command, a “memory read line” command, and a “memory read multiple” command as specified by the “PCI Local Bus Specification, Revision 2.2”. For example, the “memory read” command may be used to read or fetch a single Dword of 32-bit block of data. The “memory read line” command may be used to read or fetch more than a Dword of 32-bit block of data up to the next cache line (a complete cache line). The “memory read multiple” command may be used to read or fetch more than one cache line before disconnecting.

In addition to the command type, the bus frequency, the bus data width and cache line size may be utilized to determine variable fetch sizes in order to fetch optimized data from the main memory 124 of the memory subsystem 120 for PCI devices 190 on one side of the P64H bridge 140. The bus frequency may indicate either 33 MHz or 66 MHz based upon M66EN (66MHz_ENABLE) used as an input. The bus frequency may run at 33 to 66 MHz if M66EN is asserted, and 0 to 33 MHz if M66EN is de-asserted. In other words, the M66EN may be used to indicate to the current PCI device (bus master) 190 whether the PCI bus 60 is operating at either 33 MHz or 66 MHz. The bus data width may indicate either 32 bits or 64 bits based upon REQ64# assertion by the PCI device 190. The REQ64# may correspond to a 64-bit request. In other words, the data transfer may be at 64 bits if REQ64# is asserted by the current PCI device 190, and may be 32 bits if REQ64# is de-asserted by the current PCI device 190. Lastly, the cache line size may be either 32 bytes or 64 bytes based upon an internal register in a host bridge such as the P64H bridge 140. The length of a cache line may be defined by the Cacheline Size register in Configuration Space that is initialized by configuration software of the host bridge.

The data fetching control mechanism 146 according to the principles of the present invention may be integrated within the P64H bridge 140 rather than having a separate chip formed as a portion of the P64H bridge 140. Such a data fetching control mechanism 146 may be implemented by a cloud of logic that receives input variables such as the command type (memory read, memory read line, and memory read multiple), REQ#64, M66EN, and optional cache line size, and an index table that generates corresponding index or fetch values indicating a fetch size for fetching data from the main memory 124 of the memory subsystem 120 on one side (side A) of the P64H bridge 140 for PCI devices 190 on the other side (side B) of the P64H bridge 140.

Embodiments of the present invention may relate to an algorithm for a bridge (such as a PCI or PCI-X bridge) that may fetch data from system memory on behalf of agents on its secondary (PCI) bus. The PCI/PCI-X bus may operate at any one of a plurality of frequencies (such as 33 MHz or 66 MHz for PCI, and 66 MHz, 100 MHz or 133 MHz for PCI-X). Other frequencies and types of buses are also within the scope of the present invention. The P64H bridge 140 may operate the secondary bus and include system knowledge of the typical latencies from the main memory 124 to the bridge 140. The P64H bridge 140 may include registers to store the system knowledge. An algorithm may parse the data from these registers to perform an optimized fetch from the system memory.

The P64H bridge 140 may use system registers, as well as knowledge of the bus performance (i.e., 33, 66, 100 and 133 MHz) to fetch data from the main memory 124 through the memory controller hub 122. The values of the registers may indicate the number of bytes to fetch and the time to wait between fetches such that data may stream to the PCI/PCI-X device with no (or little) interruptions.

Data may be fetched from the system memory (such as the main memory 124) to fill-up a buffer (such as the buffer 144 in FIG. 1) and, at a fixed drain point, more data may be fetched from the system memory to fill the buffer. However, this may be static. That is, the size of the buffer 144 may be built assuming a certain latency from the system memory and a specific bus operating frequency that the component most wishes to optimize. If the latency increases, the component is coupled with a different memory controller having different latencies, or the component is used under a different bus frequency that is important to a customer, then the performance of the PCI devices may decrease because a stream of data cannot be properly maintained. Such a data fetching algorithm may result in bad performance because: (1) too much information is being obtained at one time and portions of the unused data are being discard; or (2) not enough data was being obtained for a big request. It is desirable for an algorithm to be less sensitive to latency and more programmable so that initial settings may later be changed.

Each PCI frequency in the system (i.e., 33, 66, 100 and 133 MHz) may be assigned to a set of registers in the PCI bridge. These registers may contain the following information: (1) an initial request length, (2) an initial threshold length, (3) a subsequent length, and (4) a subsequent threshold length. The initial request length represents a size of the initial request from memory when a PCI request is accepted. The initial threshold length represents the amount of data in the buffer (such as the buffer 144) that must be crossed before fetching more data from the system memory. This value may be greater than or equal to the time it takes to fetch more data from the system memory or else the stream of data may be broken. The subsequent request length may be similar to the initial request length and represents the size of the subsequent request to the system memory when the threshold is crossed. This value may be large enough such that the amount of data in the buffer is above the threshold. The subsequent threshold length may be similar to the initial threshold length and represents the amount of data in the buffer that must be crossed before fetching more data from the system memory. This value may be greater than or equal to the time it takes to fetch more data from the system memory or else the stream of data may be broken.

Two types of request/threshold pairs may be provided so subsequent requests and thresholds may be smaller if the memory controller is performing its own fetching (or prefetching) of data. If the memory controller is fetching its own data, then the time for fetching data may be greatly reduced. Therefore, the upstream PCI bus may be used more efficiently. For systems whose memory controllers are not performing fetching, the values in the initial request/threshold pair may be the same as any subsequent request/threshold pair.

When BIOS is developed for a platform, the latencies from a primary side of the bridge 140 to the system memory and back to the primary side may be provided to the BIOS. BIOS may use this information to construct the four variables discussed above for each PCI frequency and program (or store) the appropriate data into the bridge 140.

When the system boots up, each device of the system may indicate whether they are capable of running at 33, 66, 100 or 133 MHz, for example. The P64H bridge 140 may thereby determine information regarding the devices and appropriately store and determine the operating frequencies.

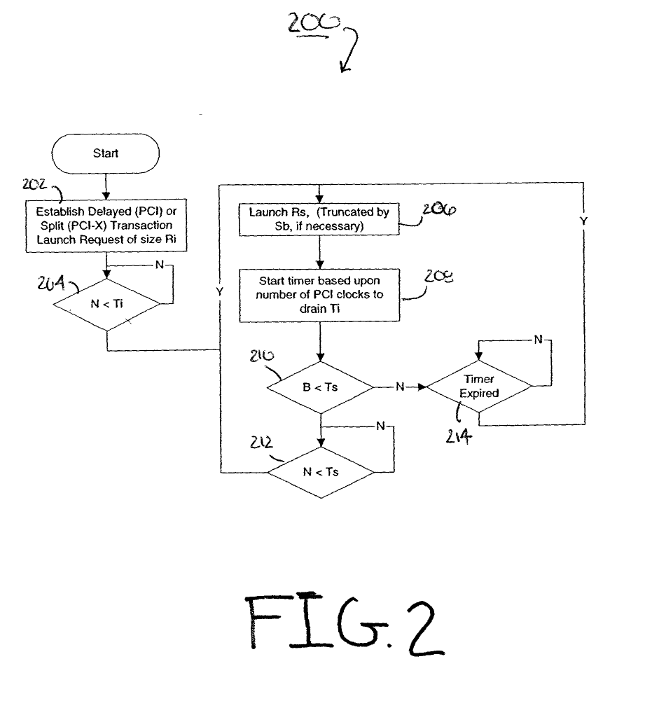

FIG. 2 is a flowchart 200 illustrating an example embodiment of the present invention. Other embodiments, orders of operation and methodologies are also within the scope of the present invention. The FIG. 2 algorithm shows how the PCI bridge 140 may fetch data on behalf of the device. At any point in the algorithm, the transfer may end and the algorithm may exit. In this algorithm, Ri represents an initial request size, Ti represents an initial threshold, Rs represents a subsequent request, Ts represents a subsequent threshold, D represents a delay to wait before the next Ts, Sb represents the buffer size, N represents the data in the buffer and the data currently being transferred (i.e., in flight) and B represents the amount of data in the buffer.

In block 202, a delayed (PCI) or split (PCI-X) transaction launch request of size Ri is established. The actual amount of data fetched may be such that the transfer ends on a naturally aligned 128-byte line. If the initial address is less than 64 bytes into the 128-byte line, then the Ri value may be rounded down (i.e., eight 64 byte lines may become seven 64 byte lines plus a remainder). If the initial address is more than 64 bytes into the 128-byte line, then the Ri value may be rounded up (i.e., eight 64 byte lines may become nine 64 byte lines plus a remainder). In a first example, the address may start 32 bytes into a 128-byte line, and the fetch length may be four 64 byte lines (or 256 bytes). The amount fetched may then be 256−32=224 bytes or 56 Dwords. In a second example, the address may start 96 bytes into a 128-byte line, and the fetch length may be four 64 byte lines (or 256 bytes). The amount fetched may then be 256+(128−96)=288 bytes or 72 Dwords.

The system may then wait until at least some data has returned. In a PCI mode, this may occur when the first qword becomes available. In a PCI-X mode, when not running in 133 MHz mode, or running in 133 MHz mode but the request size (Ri) is less than or equal to 256 bytes, this may occur when the first ADB becomes available. In a PCI-X environment operating at 133 MHz, when the request length (Ri) is greater than 256 bytes but less than or equal to 1 KB, this may occur four clocks after the first ADB becomes available. In a PCI-X environment operating at 133 MHz, when the request length (Ri) is greater than 1 KB, this may occur when 2 ADBs become available. In block 204, the algorithm determines whether the amount of data in the buffer and the data in flight (N) is less than the initial threshold (Ti). When N<Ti, a launch data request of size Rs (truncated by Sb, if necessary) is made in block 206. A timer may be started in block 208 if there are not any more active delayed transactions. In block 210, the algorithm may compare the amount of data in the buffer (B) with the subsequent threshold (Ts).

If B<Ts (affirmative result in block 210), the algorithm may wait until the amount of data in the buffer and the data in flight (N) is less than the initial threshold (Ti) in block 212. A subsequent data request may be made in block 206 and the timer may be reset in block 208. The algorithm again compares the amount of data in the buffer (B) with the subsequent threshold (Ts) in block 210.

If B>Ts (negative result in block 210), then the algorithm waits for the timer to expire in block 214. Once the timer has expired in block 214, a subsequent data launch request may be made in block 206.

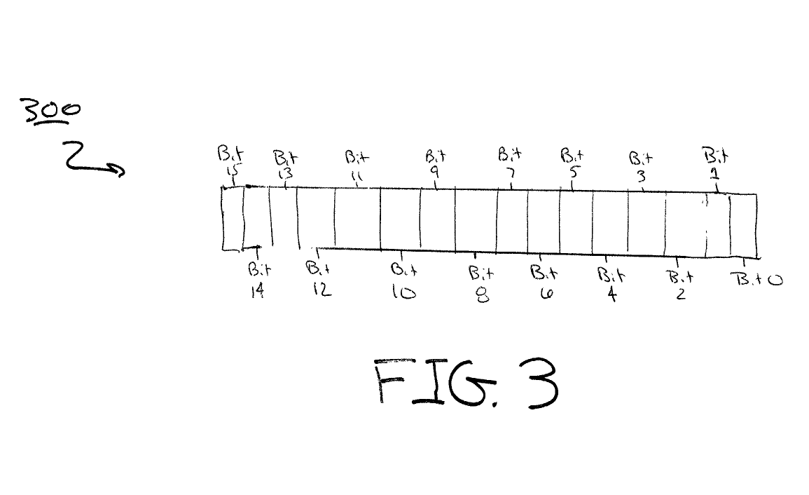

FIG. 3 is a diagram of a fetch parameter register 300 according to an example embodiment of the present invention. Other embodiments of the register are also within the scope of the present invention. The register 300 may be part of the buffer 144 provided within the P64H bridge 140. The register 300 shown includes 15 bits (labeled bits 0-15) although other numbers of bits are also within the scope of the present invention.

The bits 0-3 may correspond to the value of the initial request size (Ri), the bits 4-7 may correspond to the value of the initial threshold (Ti), the bits 8-11 may correspond to the value of the subsequent request (Rs) and the bits 12-15 may correspond to the value of the subsequent threshold (Ts).

As indicated above, each of the frequencies (such as 33, 66, 100 and 133 MHz) may correspond to a specific register each having 15 bits in this example. That is, the frequency of 33 MHz may correspond to the register 300, the frequency of 66 Hz may correspond to another register (having 15 bits), the frequency of 100 MHz may correspond to yet another register (having 15 bits) and the frequency 133 may correspond to yet another register (having 15 bits).

Thus, once the bridge 140 determines the appropriate frequency of the bus, the bridge 140 may obtain the appropriate values of Ri, Ti, Rs and Ts by indexing the appropriate register within the buffer 144. These values may then be used in the algorithm of FIG. 2.

The methodology described above including the algorithm of FIG. 2 may be provided with software (or software routines) provided in the data fetching control mechanism 146. The methodology, algorithm and/or routine may also be provided on a program storage device (such as a disk for example) that is readable by a machine (such as a computer system) and include a program of instructions that are executable by the machine to perform the methodology, algorithm and/or routine.

The present invention has been described with reference to a number of illustrative embodiments. It should be understood that numerous other modifications and embodiments can be devised by those skilled in the art that fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses may also be apparent to those skilled in the art.

What is claimed is:

1. A method of fetching data from a memory component, said method comprising:
obtaining parameters relating to data fetching from said memory component based on an operating frequency of a bus; and
fetching said data from said memory component based on said obtained parameters.

2. The method of claim 1, wherein said parameters relate to a data transfer size.

3. The method of claim 2, wherein said parameters further relate to a threshold value.

4. The method of claim 1 , wherein said parameters are obtained from values stored in a register corresponding to said frequency of said bus.

5. The method of claim 1, wherein fetching said data comprises:
fetching an initial amount of data from said memory component;
storing said initial amount of data in a storage device; and
fetching additional data from said memory component at least based on a threshold value of said storage device.

6. The method of claim 5, wherein fetching said data further comprises:
starting a timer; and
fetching additional data from said mem ory component when said timer has elapsed.

7. A mechanism to fetch data from a memory component, said mechanism comprising:
a control unit to receive an indication regarding a frequency of a bus; and
a storage device including a plurality of registers, each register to store parameters relating to data fetching based on a different frequency of said bus, said control unit to obtain said parameters based on said indication, said control device to further fetch said data from said memory component based on said parameters.

8. The mechanism of claim 7, wherein said parameters relate to a data transfer size.

9. The mechanism of claim 8, wherein said parameters further relate to a threshold value.

10. The mechanism of claim 7, wherein said control unit operates based on said parameters to:
fetch an initial amount of data from said memory component;
store said initial amount of data in said storage device; and
fetch an additional amount of data from said memory component at least based on a threshold value of said storage device.

11. The mechanism of claim 10, wherein said control unit further operates to:
start a timer; and
fetch a still further amount of data from said memory component when said timer has elapsed.

12. The mechanism of claim 7, wherein said control unit fetches a size of data from a memory subsystem on one side of a host chipset for a bus device on an opposite side of said host chipset as a function of said frequency of said bus.

13. The mechanism of claim 12, wherein said sizes of data are fetched from said memory subsystem on one side of said host chipset, via a primary bus, for the bus device on an opposite side of said host chipset, via a secondary bus.

14. The mechanism of claim 13, wherein said primary bus and said secondary bus correspond to Peripheral Component Interconnect (PCI) buses, and said host chipset corresponds to a PCI-PCI bridge of a computer system.

15. A computer system comprising:
a memory subsystem;
a host chipset to couple to said memory subsystem via a first bus; and
a bus device to couple to said host chipset via a second bus, wherein said host chipset fetches data from said memory subsystem for said bus device upon request, said host chipset comprising:
a buffer device to store data fetched from said memory subsystem via said first bus for said bus device;
a plurality of registers each to contain parameters corresponding to a different operating frequency of said second bus; and
a data fetching mechanism to receive an indication of an operating frequency of said second bus and to obtain said parameters corresponding to said operating frequency of said second bus based on said indication, said control device to fetch said data from said memory component based on said obtained parameters.

16. The computer system of claim 15, wherein said host chipset corresponds to a Peripheral Component Interconnect (PCI) 64-bit hub.

17. The computer system of claim 15, wherein said first bus and said second bus correspond to Peripheral Component Interconnect (PCI) buses, and said host chipset corresponds to a PCI-PCI bridge.

18. The computer system of claim 15, wherein said parameters correspond to: an initial request length, an initial threshold length, a subsequent request length, and a subsequent threshold length.

19. The computer system of claim 15, wherein said data fetching mechanism operates to:
fetch an initial amount of data from said memory subsystem;
store said initial amount of data in said buffer device; and
fetch an additional amount of data from said memory subsystem at least based on a threshold value of said buffer device.

20. The computer system of claim 19, wherein said data fetching mechanism further operates to:
start a timer; and
fetch a still further amount of data from said memory subsystem when said timer has elapsed.

21. A program storage device readable by machine, tangibly embodying a program of instructions executable by the machine to perform a method of fetching data from a memory component, said method comprising:
obtaining parameters relating to data fetching from said memory component based on an operating frequency of a bus; and
fetching said data from said memory component based on said obtained parameters.

22. The program storage device of claim 21, wherein fetching said data comprises:
fetching an initial amount of data from said memory component;
storing said initial amount of data in a storage device; and
fetching additional data from said memory component at least based on a threshold value of said storage device.

23. The program storage device of claim 22, wherein fetching said data further comprises:
starting a timer; and
fetching additional data from said memory component when said timer has elapsed.
